(19) United States
(12) Patent Application Publication
(10) Pub. No.: US 2018/0249032 A1
(43) Pub. Date: Aug. 30, 2018

(54) INFORMATION DISPLAY SYSTEM AND PRIMARY ELECTRONIC DEVICE

(71) Applicant: KYOCERA Document Solutions Inc., Osaka (JP)

(72) Inventor: Sumio YAMADA, Osaka (JP)

(21) Appl. No.: 15/904,459

(22) Filed: Feb. 26, 2018

(30) Foreign Application Priority Data
Feb. 28, 2017 (JP) 2017-036007

(51) Int. Cl. H04N 1/00; H04N 1/40

(52) U.S. Cl. CPC H04N 1/00795; H04N 1/40; H04N 1/0035; H04N 1/00095

(57) ABSTRACT

This information display system includes an image forming apparatus and a mobile terminal device. The image forming apparatus includes a second-generation image information generator, an image information mark generator, and an image formation controller. The second-generation image information generator creates image information of a second generation document associated with a first generation document based on user information accepted by an input accepting section and the first generation document read by a first reading unit. The image information mark generator creates an image information mark containing the image information of the second generation document, which is created by the second generation image information generator, incorporated in the image of the first generation document. The image formation controller performs control operations to form the image information mark created by the image information mark generator over the first generation document loaded on a document loading unit using an image forming unit.

### CROSS REFERENCE TO RELATED APPLICATION

This application claims priority to Japanese Patent Application No. 2017-36007, which was filed Feb. 28, 2017, and is incorporated herein by reference in its entirety.

### BACKGROUND

This disclosure relates to an information display system and a primary electronic device.

An image forming apparatus, typified by a multifunction peripheral, emits light to a photoreceptor based on image data to form an electrostatic latent image on the photoreceptor. Then, the image forming apparatus applies charged toner onto the formed electrostatic latent image to make it into a visible image that is in turn transferred onto a sheet of paper, and fixed, and then the image forming apparatus discharges the sheet of paper out of the apparatus.

There are some well-known technologies for multifunction peripheral having functions of reading images and printing the images.

A typical information providing system includes a multifunction peripheral having an image reading function and a printing function, and an information provider server connected to the multifunction peripheral via a network. The multifunction peripheral includes: a printing unit that receives print information containing code information from the information provider server and prints the print information; a reading unit that reads a sheet of paper on which the print information is printed by the printing unit and then handwritten text and figures are added; a code information analyzing unit that analyzes the code information contained in the information read by the reading unit to acquire print identification information identifying the print information printed on the sheet of paper; and a read information transmitting unit that transmits the print identification information acquired by the code information analyzing unit and the information read by the reading unit to the information provider server. The information provider server includes: a print information storing unit that stores print information, which is to be provided to the multifunction peripheral, and print identification information being associated with the print information to identify the print information; an information acquiring unit that acquires the print information from the print information storing unit, the print information being stored in association with the print identification information received from the read information transmitting unit; a handwritten information extracting unit that extracts handwritten information by comparing the read information received from the read information transmitting unit and the print information acquired by the information acquiring unit and obtaining their difference; and a provided information transmitting unit that analyzes the extracted handwritten information and inputs the analysis result to transmit new information to the multifunction peripheral. The above-described information providing system has these features.

### SUMMARY

In an aspect of the present disclosure, an information display system includes a primary electronic device having an image forming unit forming an image, and a secondary electronic device having a display unit displaying information. The primary electronic device includes a first reading unit, a document loading unit, an input accepting section, a second-generation image information generator, an image information mark generator, and an image formation controller. The first reading unit reads an image of a first generation document. The document loading unit is where the first generation document is loaded. The input accepting section accepts input of user information that is a request made by a user to the first generation document, which is read by the first reading unit. The second-generation image information generator creates image information of a second generation document associated with the first generation document based on the user information accepted by the input accepting section and the first generation document read by the first reading unit. The image information mark generator creates an image information mark containing the image information of the second generation document, which is created by the second-generation image information generator, incorporated into the image of the first generation document. The image formation controller performs control operations to form the image of the image information mark created by the image information mark generator over the first generation document loaded on the document loading unit using the image forming unit, or to form the image information mark created by the image information mark generator in the image of the first generation document. The secondary electronic device includes a second reading unit, a determination section, an extractor, and a display controller. The second reading unit reads an image of the first generation document with the image information mark added thereon. The determination section determines whether the image of the first generation document read by the second reading unit contains the image information mark. If the determination section determines that the image information mark is present on the image, the extractor extracts the image information of the second generation document from the second-generation image information generator. The display controller controls the display unit to display the image of the first generation document, which is read by the second reading unit, with the image information of the second generation document, which is extracted by the extractor, superimposed thereover.

In another aspect of the disclosure, a primary electronic device is included in an information display system that includes the primary electronic device having an image forming unit forming an image, and a secondary electronic device having a display unit displaying information. The secondary electronic device includes a second reading unit reading an image of a first generation document with an image information mark added thereon, a determination section determining whether the image of the first generation document read by the second reading unit contains the image information mark, an extractor extracting image information of the second generation document from the primary electronic device when the determination section determines the presence of the image information mark, and a display controller controlling the display unit to display the image of the first generation document, which is read by the second reading unit, with the image information of the second generation document, which is extracted by the extractor, superimposed thereover. The primary electronic device includes a first reading unit, a document loading unit, an input accepting section, a second-generation image information generator, an image information mark generator, and an image formation controller. The first reading unit reads the image of the first generation document. The document loading unit is where the first generation document is loaded. The input accepting section accepts input of user information that is a request made by a user to the first generation document, which is read by the first reading unit. The second-generation image information generator creates image information of a second generation document associated with the first generation document based on the user information accepted by the input accepting section and the first generation document read by the first reading unit. The image information mark generator creates an image information mark containing the image information of the second generation document, which is created by the second generation image information generator, incorporated in the image of the first generation document. The image formation controller performs control operations to form the image of the image information mark created by the image information mark generator over the first generation document loaded on the document loading unit using the image forming unit, or to form the image information mark created by the image information mark generator in the image of the first generation document.

### BRIEF DESCRIPTION OF THE DRAWINGS

FIG. 1 is a schematic external view of an information display system according to an embodiment of the present disclosure, the information display system including an image forming apparatus, which is embodied as a multifunction peripheral.

FIG. 2 is a block diagram showing the configuration of the information display system shown in FIG. 1.

FIG. 3 is a block diagram showing the configuration of a multifunction-peripheral control unit.

FIG. 4 is a block diagram showing the configuration of a mobile terminal device control unit.

FIG. 5 is a flowchart of a process of displaying a recommended route on a mobile terminal device based on a map document.

FIG. 6 illustrates an example map document.

FIG. 7 illustrates the map document over which an image information mark is created and formed.

FIG. 8 is a flowchart of a process of viewing the map document through the mobile terminal device.

FIG. 9 illustrates the map document displayed on the touch panel.

FIG. 10 shows example views of the touch panel when the touch panel displays narrow areas.

FIG. 11 illustrates an example map document with a rederived recommended route displayed on the touch panel.

### DETAILED DESCRIPTION

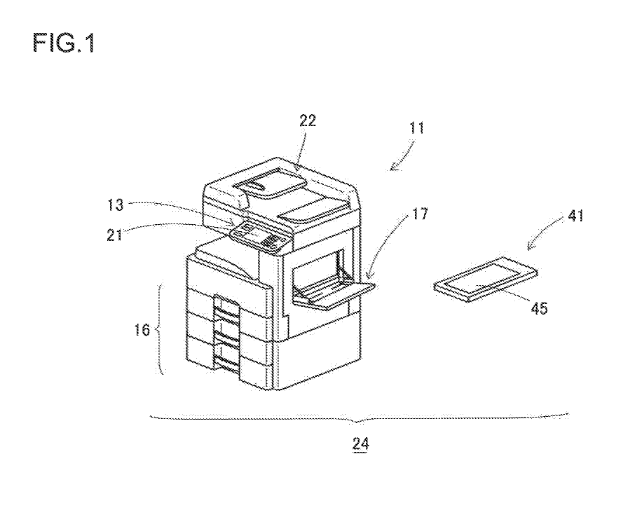

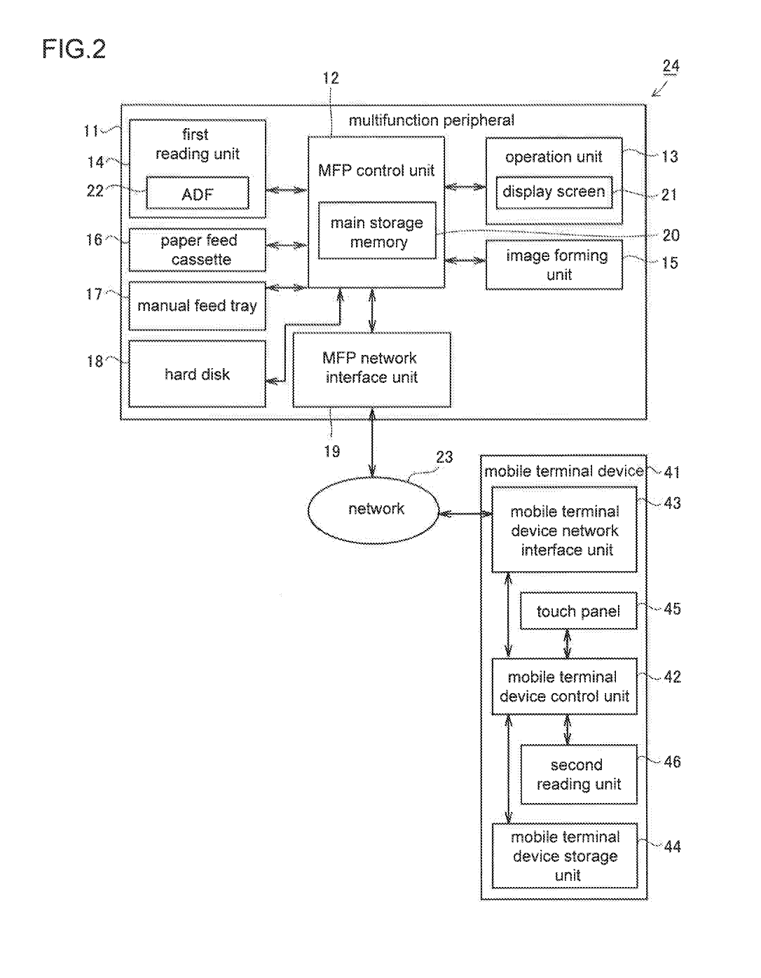

Reference is made below to an embodiment of the present disclosure. FIG. 1 is a schematic external view of an information display system 24 according to the embodiment of the present disclosure. The information display system includes an image forming apparatus, which is embodied as a multifunction peripheral. FIG. 2 is a block diagram showing the configuration of the information display system 24 shown in FIG. 1.

Referring to FIGS. 1 and 2, the information display system 24 includes a multifunction peripheral 11, which serves as a primary electronic device, including an image forming unit 15 for forming images, and a mobile terminal device 41, which serves as a secondary electronic device, including a touch panel 45, which serves as a display unit, for displaying information. Examples of the mobile terminal device 41 include a smartphone, a tablet PC, and other types of portable devices.

First, the configuration of the multifunction peripheral 11 will be described. The multifunction peripheral 11 includes a multifunction peripheral control unit 12 (hereinafter, referred to as an MFP control unit 12), an operation unit 13, a first reading unit 14, an image forming unit 15, paper feed cassettes 16, a manual feed tray 17, a hard disk 18, and a network interface unit 19 used to connect with a network 23. The MFP control unit 12 controls the entire multifunction peripheral 11. The MFP control unit 12 is composed of a central processing unit (CPU) and some other components, and includes a main storage memory 20 that temporarily stores data. The operation unit 13 includes a touch panel type display screen 21 that displays information submitted from the multifunction peripheral 11 and entries made by users. The operation unit 13 accepts input, from users, regarding image formation, such as image forming conditions including the number of prints and gradation degrees. The first reading unit 14 includes an auto document feeder (ADF) 22, which serves as a document transporting device, that transports a document placed on a loading position to a reading position. The first reading unit 14 reads the image of a document loaded in the ADF 22 or a document placed on a document table. Each of the paper feed cassettes 16 can hold a plurality of sheets of paper. The manual feed tray 17 is provided on a side of the multifunction peripheral 11 and allows users to manually load sheets of paper on which images will be formed. The paper feed cassettes 16 and manual feed tray 17 function as a document loading unit on which a first generation document, which will be described later, is loaded. The image forming unit 15 forms an image on paper transported from the paper feed cassettes 16 or the manual feed tray 17 based on image data of a document read by the first reading unit 14 or image data transmitted via the network 23. The hard disk 18 stores data relating to image formation, such as transmitted image data and input image forming conditions. The aforementioned first generation document is a map document presenting a map.

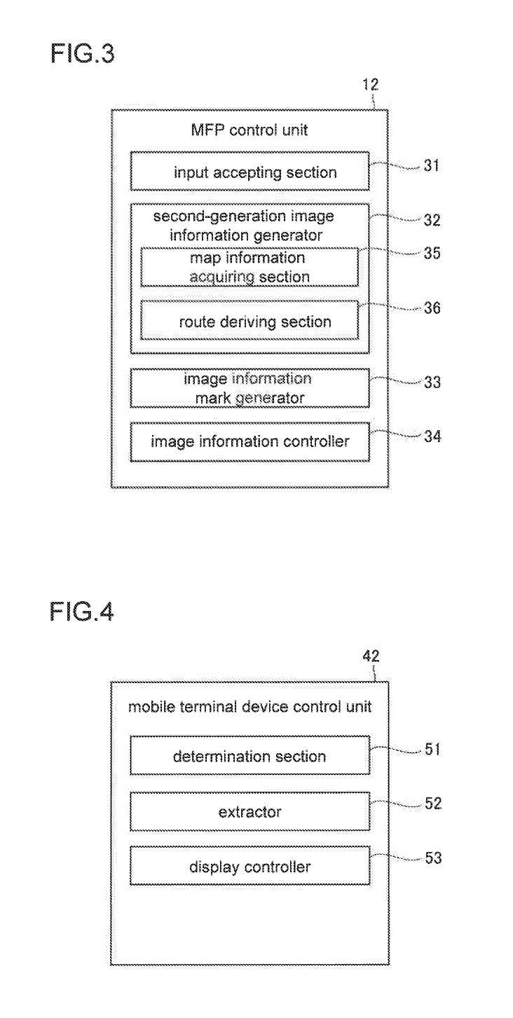

Next, the configuration of the MFP control unit 12 provided in the multifunction peripheral 11 will be described. FIG. 3 is a block diagram showing the configuration of the MFP control unit 12. Referring to FIG. 3, the MFP control unit 12 includes an input accepting section 31, a second-generation image information generator 32, an image information mark generator 33, and an image formation controller 34. The input accepting section 31 accepts input of user information that is a request made by a user to a first generation document read by the first reading unit 14. The aforementioned operation unit 13 operates as the input accepting section 31. Based on the user information accepted by the input accepting section 31 and a map document read by the first reading unit 14, the second-generation image information generator 32 creates image information of a second generation document associated with the map document. The image information mark generator 33 creates an image information mark containing the image information of the second generation document, which is created by the second-generation image information generator 32, incorporated in the image of the map document. The image formation controller 34 controls the image forming unit 15 to form an image of the image information mark created by the image information mark generator 33 over the first generation document transported from the document loading unit.

The second-generation image information generator 32 includes a map information acquiring section 35 and a route deriving section 36. The map information acquiring section 35 acquires scale information, which is information about the scale of the map, and positional information, which is information about positions indicated on the map, from the image of the map document read by the first reading unit 14. The route deriving section 36 derives a recommended route from a departure point to a destination point based on the scale information and positional information acquired by the map information acquiring section 35, and departure point information and destination point information accepted through the input accepting section 31. In addition, the image information mark generator 33 creates an image information mark containing information about the recommended route derived by the route deriving section 36 as the image information of the second generation document. The configuration of these elements will be described later in detail.

Next, the configuration of the mobile terminal device 41 will be described. The mobile terminal device 41 includes a mobile terminal device control unit 42, a mobile terminal device network interface unit 43 used to connect with the network 23, a mobile terminal device storage unit 44, a touch panel 45 serving as a display unit displaying information, and a second reading unit 46 reading the image of a document with an image information mark added thereon. The mobile terminal device control unit 42 controls the entire mobile terminal device 41. The mobile terminal device storage unit 44 stores image data and other various types of data. The touch panel 45 displays information of the mobile terminal device 41 and also functions as an input interface. The second reading unit 46 captures the image of a document of interest by using a camera mechanism provided on the opposite side to the touch panel 45 to read the image of the document. The second reading unit 46 is designed to be capable of reading images of regular documents on which no image information marks are added.

Next, the configuration of the mobile terminal device control unit 42 in the mobile terminal device 41 will be described. FIG. 4 is a block diagram showing the configuration of the mobile terminal device control unit 42. Referring to FIG. 4, the mobile terminal device control unit 42 includes a determination section 51, an extractor 52, and a display controller 53. The determination section 51 determines whether the image of a map document read by the second reading unit 46 contains an image information mark. If the determination section 51 determines that the image information mark is present on the image, the extractor 52 extracts the image information of the second generation document from the second-generation image information generator 32 of the multifunction peripheral 11. The display controller 53 controls the touch panel 45 to display the image of the map document, which is read by the second reading unit 46, with the image information of the second generation document, which is extracted by the extractor 52, superimposed thereover. The configuration of these elements will be also described later in detail.

In what follows, description will be given about how the above-described information display system 24 displays a recommended route on the mobile terminal device 41 using a map document, which is a first generation document, presenting a map.

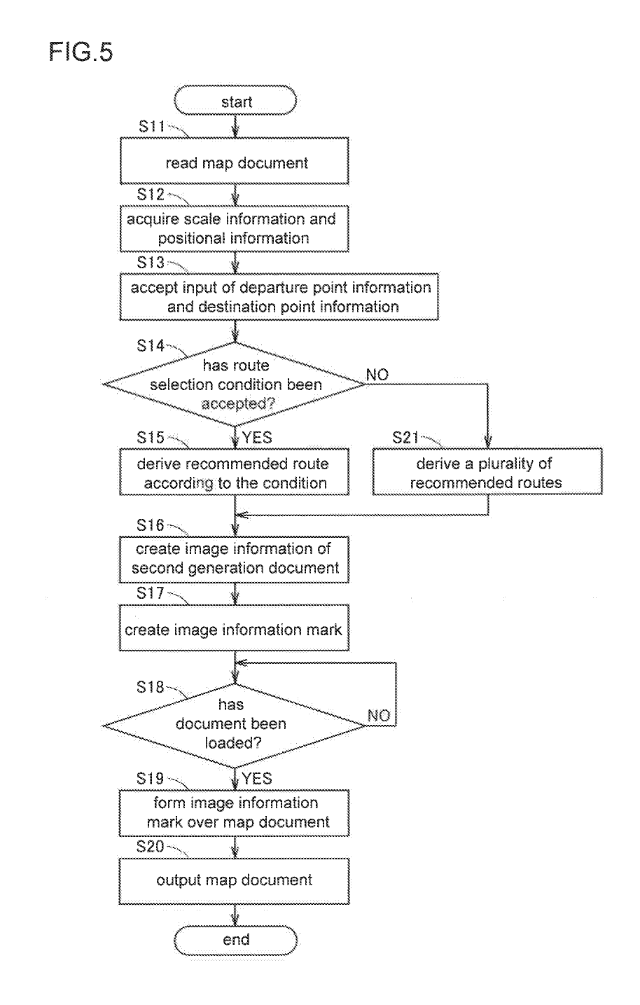

FIG. 5 is a flowchart of the process of displaying a recommended route on the mobile terminal device 41 based on the map document. Referring to FIG. 5, firstly, a user places a map document on the ADF 22. The MFP control unit 12 detects the placement of the map document, and controls the first reading unit 14 to read the image of the map document in response to a press of the start key on the operation unit 13 (step S11 in FIG. 5, hereinafter “step” is omitted).

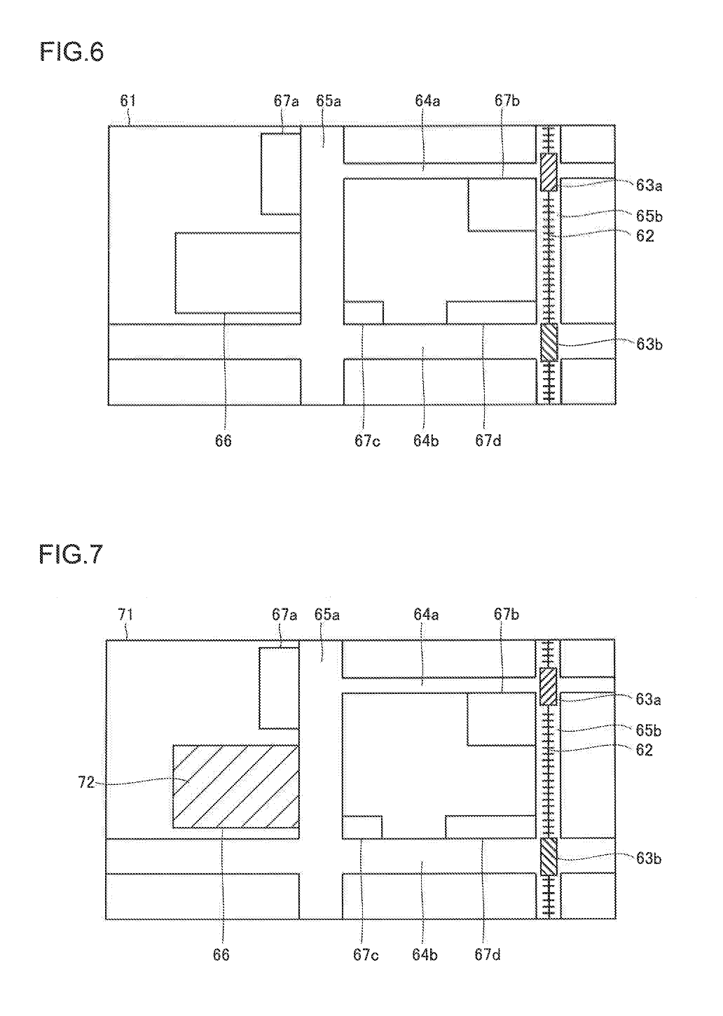

A brief description will be made about the map document, which is a first generation document, to be read by the first reading unit 14. FIG. 6 illustrates an example of the map document. On the map document, north is at the top. Referring to FIG. 6, the map document 61 indicates a first station 63a and a second station 63b connected to the first station 63a with a railroad track 62 extending in a north-south direction. In other words, the first station 63a is located next to the second station 63b. The first station 63a is situated on the north side. The map document 61 also indicates two roads 64a, 64b spaced apart in the north-south direction and extending in the east-west direction, and two roads 65a, 65b spaced apart in the east-west direction and extending in the north-south direction. The road 65b extends along the railroad track 62. The first station 63a is situated at the intersection of the road 64a and road 65b. The second station 63b is situated at the intersection of the road 64b and road 65b. In addition, the map document 61 indicates a building 66 on the road 65a and near the road 64b, in other words, near the intersection of the road 65a and road 64b. Furthermore, other buildings 67a, 67b, 67c, 67d, which could be landmarks, are presented on the map document 61. Coordinate information, more specifically, latitude and longitude of the building 66, first station 63a, and other structures may be registered in advance as famous constructions plotted on a map of Japan and stored in a hard disk 18.

The first reading unit 14 reads the image of the map document 61. The map information acquiring section 35 acquires scale information, which is information about the scale of the map document 61, and positional information, which is information about positions indicated on the map document 61, from the image read by the first reading unit 14 (S12).

If scale information is provided in the map document 61, the scale information is used. Specifically, when scale information is presented in numbers or characters, the numbers and characters are read out from the image of the map document 61 by using an optical character recognition (OCR) mechanism, and are used as scale information. On the other hand, when scale information is not presented on the map document 61, the scale information can be acquired by calculations. For example, the names of objects presented on the map document 61, more specifically, the names of the first station 63a and second station 63b on the map document 61 are extracted by the OCR mechanism to obtain the actual distance between the first station 63a and second station 63b, and the actual distance is used to calculate the scale information of the map document 61. In short, the map information acquiring section 35 acquires scale information by calculation using the information about objects presented on the map document 61, which is read by the first reading unit 14. The information about the actual distance between the first station 63a and second station 63b may be acquired from the Internet via the network 23, or may be acquired from the hard disk 18 if detailed information about a map of Japan is stored in the hard disk 18 in advance.

If the names of the first station 63a, second station 63b, roads 64a, 64b, 65a, 65b are indicated on the map document 61, the names are read by the OCR mechanism and utilized as positional information. Specifically, the latitude and longitude data of the first station 63a and other constructions stored in the hard disk 18 is used to acquire the positional information. The positional information also can be acquired by using latitude and longitude data derived from the names of the buildings 66, 67a to 67d presented on the map document 61.

Next, departure point information and destination point information are acquired (S13). The departure point information and destination point information are input through the display screen 21, or other input means, of the operation unit 13 serving as the input accepting section 31. Specifically, the image of the map document 61 read by the first reading unit 14 is displayed on the display screen 21, and the user touches positions on the map document 61 displayed on the display screen 21 to designate a departure point and a destination point that are in turn detected as the departure point information and destination point information.

After that, it is determined whether a condition to select a recommended route has been accepted (S14). The selection condition is also input through the input accepting section 31. Specifically, for example, the user enters characters or numerals using the display screen 21 of the operation unit 13 to input the selection condition.

If the selection condition for a recommended route has been accepted (YES in S14), the route deriving section 36 provides a recommended route connecting the departure point to the destination point in accordance with the accepted selection condition for the recommended route (S15).

The second-generation image information generator 32 creates image information of a second generation document associated with the map document based on the derived recommended route, which may be for example the shortest distance route connecting the departure point to the destination point (S16). Then, the image information mark generator 33 creates an image information mark containing the image information of the second generation document created by the second-generation image information generator 32 incorporated in the image of the map document (S17). The image information mark herein is, for example, a mark, such as a two-dimensional barcode shaped to fit in the shape of the building at the destination point.

The user loads the map document 61 on the manual feed tray 17 serving as a document loading unit after having the map document 61, which is a first generation document, read by the first reading unit 14. When the image formation controller 34 detects the presence of the map document 61, which is a first generation document, on the manual feed tray 17 (YES in S18), the controller 34 controls the image forming unit 15 to form an image of the image information mark created by the image information mark generator 33 over the loaded map document 61. Subsequently, the map document 61 is output as a map document 71 with the image of the image information mark formed thereon (S20).

FIG. 7 shows the map document 71 over which the image information mark is formed. Referring to FIG. 7, in addition to the railroad track 62, stations 63a, 63b, roads 64a, 64b, 65a, 65b, buildings 66a to 66d which have been presented on the above-described map document 61, the map document 71 presents an image information mark 72 over the building 66a. The image information mark 72 is an augmented reality (AR) marker. In other words, the image information mark 72 represented by a two-dimensional barcode is formed over the building 66a by the image formation controller 34. In order to provide clear understanding, the image information mark 72 presented on the map document 71 in FIG. 7 is filled with a hatch pattern. The image information mark 72 contains image information created by the second-generation image information generator 32. In other words, the image information of the second generation document is added to the map document 61.

If a route selection condition has not been accepted in S14 (NO in S14), a plurality of recommended routes will be derived. Concretely, the plurality of recommended routes are derived in terms of a “quickest route” that takes the shortest time from the departure point to the destination point, a “shortest route” that is the shortest distance from the departure point to the destination point, a “safe route” composed of wide roads with relatively fewer pedestrians and less traffic, and a “rainy day route” composed of many shopping streets and arcaded streets that provide less chance for pedestrians without umbrellas to get wet from the rain (S21). Subsequent steps from S16 after the plurality of recommended routes have been derived are the same as described above.

Next, description will be made about the case where the first generation document output in the above-described manner, or more specifically, the map document 71 over which the image information mark is formed is viewed with the mobile terminal device 41.

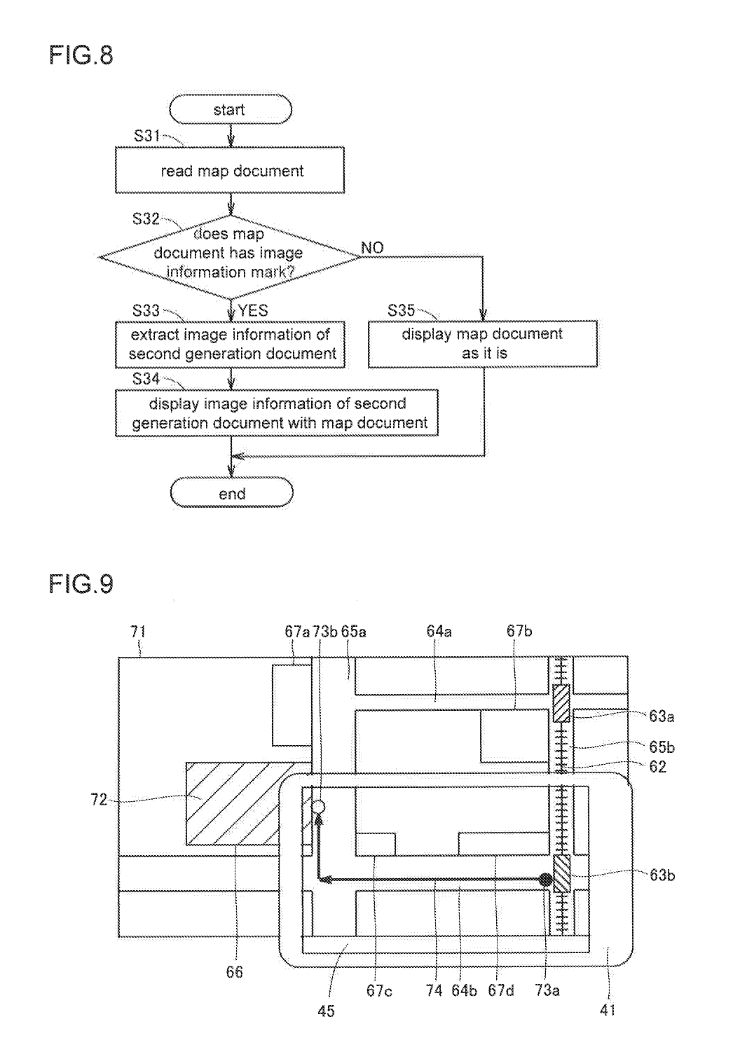

FIG. 8 is a flowchart of the process of viewing the map document 71 with the mobile terminal device 41. Referring to FIG. 8, when the map document 71 is viewed through the mobile terminal device 41, the second reading unit 46 reads the image of the map document 71 using its camera function (S31). Then, the determination section 51 determines whether the read image of the map document 71 has an image information mark 72 (S32). If the determination section 51 determines that there is no image information mark 72 in the map document 71 (NO in S32), the image is recognized as an image of a usually-used general document, and is displayed on the touch panel 45 as it is (S35). In this example in which the determination section 51 determines that there is an image information mark 72 in the map document 71 (YES in S32), the extractor 52 extracts image information of the second generation document from the second-generation image information generator 32 (S33). The display controller 53 controls the touch panel 45 to display the image of the first generation map document 71, which is read by the second reading unit 46, with the image information of the second generation document, which is extracted by the extractor 52, superimposed thereover.

FIG. 9 illustrates the map document 71 displayed on the touch panel 45. Referring to FIG. 9, the touch panel 45 displays the map document 71, and also displays a departure point 73a and a destination point 73b, which are both input by a user, and a recommended route 74 from the departure point 73a to the destination point 73b represented by arrows. In other words, the departure point 73a, destination point 73b, and recommended route 74 are not presented on the map document 71, but are displayed on the touch panel 45 of the mobile terminal device 41. In this case, both the departure point 73a and destination point 73b are displayed so as to fit within the screen of the touch panel 45. The departure point 73a and destination point 73b are represented by a black dot and a white dot, respectively. The image shown in FIG. 9, that is, the image presenting the recommended route 74 and other objects on the touch panel 45 is an image of the second generation document.

According to the information display system 24, the multifunction peripheral 11 reads the map document 61, creates image information of a second generation document associated with the image of the map document 61 based on user information accepted by the input accepting section 31, further creates an image information mark 72, and forms the image information mark 72 over the map document 61. If the mobile terminal device 41 determines the presence of the image information mark 72, the mobile terminal device 41 extracts image information of the second generation document from the second-generation image information generator 32, and displays the image information of the second generation document on the touch panel 45 of the mobile terminal device 41. This configuration allows the creation of image information of a second generation document, which meets the user's request, but it is not prepared in advance, and incorporates the image information into the map document 71. In addition, this configuration enables the user to obtain the user's required information with a single document. Therefore, the user's convenience can be improved.

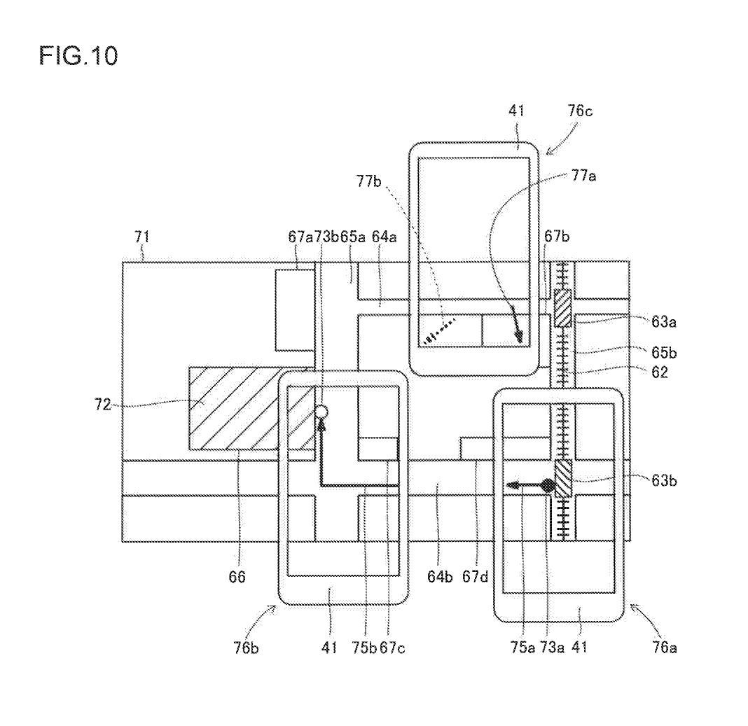

The display controller 53 can perform control operations to provide the following views. FIG. 10 shows example views on the touch panel 45 when displaying a relatively narrower range. Referring to FIG. 10, when the mobile terminal device 41 is located at a position 76a in FIG. 10, or more specifically, when the touch panel 45 does not cover the destination point 73b, but covers the vicinity of the departure point 73a within the display screen area thereof, the display controller 53 performs control operations to display the departure point 73a and a part of the recommended route 75a starting from the departure point 73a in the display screen area. When the mobile terminal device 41 is located at a position 76b in FIG. 10, or more specifically, when the touch panel 45 does not cover the departure point 73b, but covers the vicinity of the destination point 73b within the display screen area thereof, the display controller 53 performs control operations to display the destination point 73b and a part of the recommended route 75b heading to the destination point 73b in the display screen area. When the mobile terminal device 41 is located at a position 76c in FIG. 10, or more specifically, when the touch panel 45 covers neither of the departure point 73a and destination point 73b, but covers another area of the map document 71 within the display screen area thereof, the display controller 53 performs control operations to display an arrow 77a directing to the departure point 73a and an arrow 77b directing to the destination point 73b in the display screen area. Incidentally, the information about the position of the mobile terminal device 41, that is, the present location of the user carrying the mobile terminal device 41 can be acquired by a global positioning system (GPS) function or the like provided in the mobile terminal device 41.

In addition, the display controller 53 can perform control operations to provide the following view. Specifically, the display controller 53 performs control operations to display a plurality of recommended routes derived in S21 when a condition for selecting a recommended route has not been accepted in S14. This view allows the user to select a desired route from the displayed recommended routes when a route selection condition has not been accepted in S14, thereby offering the user a wide choice of options.

In this view, the recommended routes can be displayed one by one as selected by the user. Displaying the recommended routes one by one on the touch panel 45 makes it easier for the user to see. There are several ways to display the recommended routes. For example, the recommended routes are switched over at regular time intervals, or one of the recommended routes selected by the user is presented in a solid line or applied with a color, while the other recommended routes are presented in a dotted line or applied with a different color.

In a case where an event that is likely to obstruct the displayed recommended route has occurred in the above-described embodiment, the information display system 24 can be configured to acquire information about the event so as to display the information on the recommended route. Specifically, if the route deriving section 36 acquires the information about the obstructive event on the recommended route, it rederives a recommended route based on the information about the obstructive event on the recommended route.

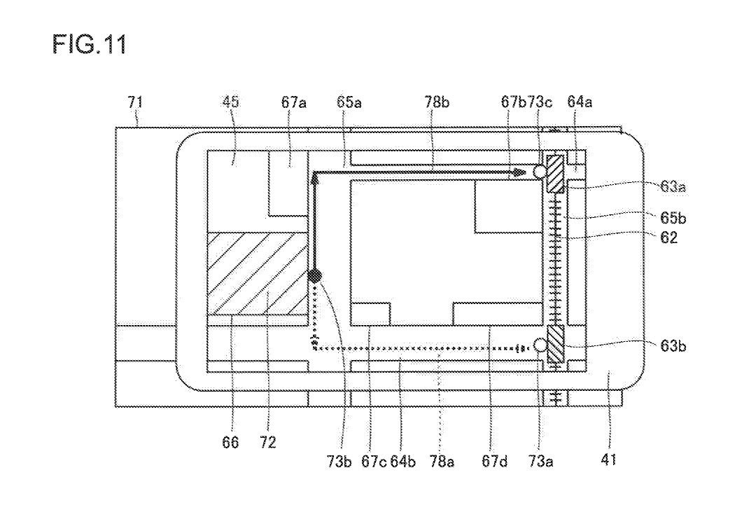

FIG. 11 shows an example of the map document 71 displayed on the touch panel 45 with the rederived recommended route. Referring to FIG. 11, the touch panel 45 displays a way back from the building 66, which was a destination point, but is now set as a departure point. If the road 64b is closed because of an accident or some other reasons, the route deriving section 36 derives a new recommended route from the building 66 to the first station 63a instead of the originally derived recommended route, which is the quickest route, from the building 66 to the second station 63b. Then, the recommended route 78a, which is the original recommended route derived before the accident, starting from the building 66 to the second station 63b is represented by a dashed line, while the recommended route 78b starting from the building 66 to the first station 63a that is connected to the second station 63b through the railroad track 62 without passing through the road 64b is represented by a solid line. This configuration can furnish the user with more useful information coinciding with the real situation. The rederivation of a recommended route is can also be applied, for example, when information about the delay of a train running on the railroad track 62 is acquired, or for other situations.

Suppose that, for example, a user who carries a map document 71 with an image information mark 72 formed thereon and a mobile terminal device 41 goes to the place, or more specifically the location indicated on the map document 71. If the road 64b is closed, the user prints an image information mark again on the map document 71 using a multifunction peripheral 11 installed in, for example, a nearby convenience store, thereby more easily acquiring information of an optimal recommended route desired by the user.

In the embodiment described above, a map document is used as a first generation document; however, the present disclosure is not limited thereto, but can use other types of documents, for example, an earlier version of a public transport timetable as the first generation document. In this case, the latest version of the public transport timetable is a second generation document. On the display, the times on the latest timetable may be displayed over the times of the earlier timetable, or the times on the latest timetable may appear at positions deviated from the times of the earlier timetable. If the timetable has changed over a plurality of generations, the times of the plurality of timetables may be displayed. In this case, the times may be color-coded for each generation. The timetables of different generations can be acquired from the Internet or other sources via the network 23.

In the embodiment described above, the input accepting section 31 is configured to accept an input made through the display screen 21 of the operation unit 13; however, the present disclosure is not limited thereto, and the input accepting section 31 can accept input of a handwritten note about a destination point or other landmarks or a ticket with a destination point printed thereon read by the first reading unit 14.

By the way, the map document 61, which is read by the first reading unit 14, may be a simple map that is made by simplifying detailed information and is often provided from stores, for example, restaurants and supermarkets. On such a simple map, the distance between roads and the position of a target building may be slightly different from the actual distance and position. Even when using a highly abstracted map, the positional information of the stores is calculated using their addresses to provide consistency between the roads and buildings on the map and the actual roads and buildings. The data of the stores obtained by calculations is stored and accumulated in the hard disk 18. The accumulated data can be used to acquire positional information that will be needed from then on, and thereby can help acquire highly accurate positional information.

In the embodiment described above, a recommended route from a departure point to a destination point is displayed; however, the present disclosure is not limited thereto, and other types of information can be displayed as image information of a second generation document. For example, the information may be about an area on the map of the past, such as information that there used to be an agricultural field, a river, or a pond. The information can be acquired from map information of the past stored in the hard disk 18.

In the embodiment described above, the image information mark 72 is formed at the position where the building 66 stands; however, the present disclosure is not limited thereto, and the image information mark 72 can be formed, for example, at any positions that do not overlap the recommended route, or at any blank positions in the map document 71. In short, the image formation controller 34 can be configured to form an image of an image information mark 72 in a blank space of the map document 71.

In the embodiment described above, the image formation controller 34 is configured to control the image forming unit 15 to form an image information mark created by the image information mark generator 33 over the first generation document loaded on the document loading unit; however, the present disclosure is not limited thereto, and the image formation controller 34 can be configured to form the image information mark created by the image information mark generator 33 in the image of the first generation document. In short, the image formation controller 34 creates an image of the first generation document in which an image information mark is added, and outputs the image onto a single sheet of paper. Thus, one single document can provide the user's required information. Therefore, the user's convenience can be improved.

In the embodiment described above, it is possible to configure such that the multifunction peripheral 11, serving as a primary electronic device, transmits image information of the second generation document associated with the first generation document to a storage device that is connected to an electric public line that connects the multifunction peripheral 11 and the mobile terminal device 41 serving as a secondary electronic device, and the extractor 52 extracts the second generation document associated with the first generation document from the storage device.

In the embodiment described above, an image forming apparatus is adopted as the primary electronic device; however, the present invention is not limited thereto, and the primary electronic device can be other devices including an image forming unit that forms images. In addition, a mobile terminal device is adopted as the secondary electronic device; however, the present disclosure is not limited thereto, and the secondary electronic device can be other devices including a display unit that displays information. Furthermore, the primary electronic device and secondary electronic device can have a common configuration.

The primary electronic device according to the present disclosure may be configured as follows. The primary electronic device according to the present disclosure is included in an information display system that includes the primary electronic device having an image forming unit forming images, and a secondary electronic device having a display unit displaying information. The secondary electronic device further includes a second reading unit reading an image of a first generation document with an image information mark added thereon, a determination section determining whether the image of the first generation document read by the second reading unit contains the image information mark, an extractor extracting image information of a second generation document from the primary electronic device when the determination section determines the presence of the image information mark, and a display controller controlling the display unit to display the first generation document, which is read by the second reading unit, with the image information of the second generation document, which is extracted by the extraction section, superimposed thereover. The primary electronic device includes a first reading unit, a document loading unit, an input accepting section, a second-generation image information generator, an image information mark generator, and an image formation controller. The first reading unit reads an image of a first generation document. The document loading unit is where the first generation document is loaded. The input accepting section accepts input of user information that is a request made by a user to the first generation document, which is read by the first reading unit. The second-generation image information generator creates image information of a second generation document associated with the first generation document based on the user information accepted by the input accepting section and the first generation document read by the first reading unit. The image information mark generator creates an image information mark containing the image information of the second generation document, which is created by the second generation image information generator, incorporated in the image of the first generation document. The image formation controller performs control operations to form the image information mark created by the image information mark generator over the first generation document loaded on the document loading unit using the image forming unit, or to form the image information mark created by the image information mark generator in the image of the first generation document. The primary electronic device can be configured in the above-described manner.

It should be understood that the embodiment disclosed herein is illustrative and non-restrictive in every respect. The scope of the present disclosure is defined by the terms of the claims, rather than by the foregoing description, and is intended to include any modifications within the scope and meaning equivalent to the terms of the claims.

The information display system and the primary electronic device according to the present disclosure can be effectively used especially to meet a demand for improving user convenience.

What is claimed is:

1. An information display system comprising a primary electronic device including an image forming unit forming an image, and a secondary electronic device including a display unit displaying information, wherein
the primary electronic device includes:
a first reading unit that reads an image of a first generation document;
a document loading unit on which the first generation document is loaded;
an input accepting section that accepts input of user information that is a request made by a user to the first generation document, which is read by the first reading unit;
a second-generation image information generator that creates image information of a second generation document associated with the first generation document based on the user information accepted by the input accepting section and the first generation document read by the first reading unit;
an image information mark generator that creates an image information mark containing the image information of the second generation document, which is created by the second-generation image information generator, incorporated in the first generation document; and
an image formation controller that performs control operations to form the image information mark created by the image information mark generator over the first generation document loaded on the document loading unit using the image forming unit, or to form the image information mark in the image of the first generation document, wherein
the secondary electronic device includes:
a second reading unit that reads the image of the first generation document with the image information mark added thereon;
a determination section that determines whether the image of the first generation document read by the second reading unit contains the image information mark;
an extractor that, if the determination section determines that the image information mark is present on the image, extracts the image information of the second generation document from the second-generation image information generator; and
a display controller that controls the display unit to display the image of the first generation document, which is read by the second reading unit, with the image information of the second generation document, which is extracted by the extractor, superimposed thereover.

2. The information display system according to claim 1, wherein
the primary electronic device transmits the image information of the second generation document associated with the first generation document to a storage device connected to an electric public line connected to the primary electronic device and the secondary electronic device, and the extractor extracts the second generation document associated with the first generation document from the storage device.

3. The information display system according to claim 1, wherein
the primary electronic device and the secondary electronic device have a common configuration.

4. A primary electronic device included in an information display system that includes the primary electronic device having an image forming unit forming an image, and a secondary electronic device that includes a display unit displaying information, a second reading unit reading an image of a first generation document with an image information mark added thereon, a determination section determining whether the image of the first generation document read by the second reading unit contains the image information mark, an extractor extracting image information of a second generation document from the primary electronic device when the determination section determines the presence of the image information mark, and a display controller controlling the display unit to display the first generation document, which is read by the second reading unit, with the image information of the second generation document, which is extracted by the extraction section, superimposed thereover, the primary electronic device comprising:
a first reading unit that reads the image of the first generation document;
a document loading unit on which the first generation document is loaded;
an input accepting section that accepts input of user information that is a request made by a user to the first generation document, which is read by the first reading unit;
a second-generation image information generator that creates image information of the second generation document associated with the first generation document based on the user information accepted by the input accepting section and the first generation document read by the first reading unit;
an image information mark generator that creates the image information mark containing the image information of the second generation document, which is created by the second-generation image information generator, incorporated in the first generation document; and
an image formation controller that performs control operations to form the image information mark created by the image information mark generator over the first generation document loaded on the document loading unit using the image forming unit, or to form the image information mark in the image of the first generation document.

5. The primary electronic device according to claim 4, wherein
the first generation document includes a map document presenting a map,
the input accepting section accepts input of information about a departure point and a destination point of a user who carries the secondary electronic device,
the second-generation image information generator includes
a map information acquiring section that acquires scale information, which is information about the scale of the map, and positional information, which is information about positions indicated on the map, from the image of the map document read by the first reading unit, and
a route deriving section that derives a recommended route from the departure point to the destination point based on the scale information and positional information acquired by the map information acquiring section, and departure point information and destination point information accepted through the input accepting section, wherein
the image information mark generator creates the image information mark containing information about the recommended route derived by the route deriving section as the image information of the second generation document,
the extractor extracts the information of the recommended route from the image information mark, and
the display controller controls the display unit to display the information of the recommended route.

6. The primary electronic device according to claim 5, wherein
the route deriving unit derives a plurality of the recommended routes, and
the display control unit controls the display unit to display the plurality of the recommended routes.

7. The primary electronic device according to claim 5, wherein
the map information acquiring section acquires the scale information by calculation from information about objects presented on the map document read by the first reading unit.

8. The primary electronic device according to claim 5, wherein
when information about an event obstructing the recommended route is acquired, the route deriving unit rederives a recommended route based on the information about the event obstructing the recommended route.

9. The primary electronic device according to claim 5, wherein
the image formation controller performs control operation to form the image of the image information mark in a blank space of the first generation document.
